(19) United States
(12) Patent Application Publication
(10) Pub. No.: US 2015/0356509 A1
(43) Pub. Date: Dec. 10, 2015

(54) CUSTOMER RELATIONSHIP MANAGEMENT MESSAGING INTEGRATION

(71) Applicant: SugarCRM Inc., Cupertino, CA (US)

(72) Inventor: Lila Tretikov, Los Gatos, CA (US)

(21) Appl. No.: 14/295,710

(22) Filed: Jun. 4, 2014

(51) Int. Cl. G06Q 10/10; H04L 12/58

(52) U.S. Cl. CPC G06Q 10/107; H04L 51/046

(57) ABSTRACT

Embodiments of the present invention provide for CRM messaging integration. In an embodiment of the invention, a method for CRM messaging integration is provided. The method includes receiving a message in a messaging application executing in memory of a computer in a process address space that differs from a co-executing CRM application. The method also includes parsing at least a part of the message to determine a context for the message and transmitting the context for the message to the co-executing CRM application. The method even further includes receiving from the CRM application CRM data pertaining to the context. Finally, the method includes displaying a prompt in a user interface for the messaging application with the CRM data.

### BACKGROUND OF THE INVENTION

1. Field of the Invention

The present invention relates to customer relationship management (CRM) computing systems and more particularly to integrating messaging with the CRM business opportunity function.

2. Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

The advent of the Internet has changed the changed the way in which end users approach CRM strategies because advances in technology have also changed consumer buying behavior and especially the way in which businesses communicate with customers and collect data about those customers. More than the past, self-service channels such as the World Wide Web (“Web”) and more recently, the mobile computing world, have become the norm rather than the exception leading to easier ways in which to manage customer information electronically. The user interface to a CRM system is generally crafted as separate fully independent application, for example as an application running “in-browser” as a Web application or “stand-alone” on the desktop. It is generally assumed that the complexity of such an application is too great to embed is as part of another broad-usage application invention.

Even still, many processes within CRM begin with a communication from customer to vendor. Those communications generally are in the form of an electronic message, such as an e-mail, text message or instant message. In either case, a computer program specifically adapted to process the electronic message receives the electronic message and presents that message to the operator. The operator in turn must manually determine how the electronic message might relate to a record in a co-executing CRM system and apply manual input to the CRM system. In some instances, the CRM system may include an embedded e-mail client, however, most operators prefer to use widely utilized e-mail clients not specifically adapted for a particular CRM system.

Regardless, failure by the operator to correlate the electronic message with a record in the CRM system can result in a failure to properly utilize the CRM system. In this regard, to the extent that the electronic communication pertains to an active matter in the CRM system such as a business opportunity, failure to process the electronic communication in connection with the active matter can result in a breakdown in the CRM process for that active matter.

### BRIEF SUMMARY OF THE INVENTION

Embodiments of the present invention address deficiencies of the art in respect to CRM management of electronic messages and provide a novel and non-obvious method, system and computer program product for CRM messaging integration. In an embodiment of the invention, a method for CRM messaging integration is provided. The method includes receiving a message in a messaging application executing in memory of a computer in a process address space that differs from a co-executing CRM application. The method also includes parsing at least a part of the message to determine a context for the message and transmitting the context for the message to the co-executing CRM application. The method even further includes receiving from the CRM application CRM data pertaining to the context. Finally, the method includes displaying a prompt in a user interface for the messaging application with the CRM data.

In one aspect of the embodiment, the CRM data is both an identity of a customer referenced in the CRM application and also an open business opportunity record associated in the CRM application with the customer. As such, the end user can be prompted in the messaging application to return the message with haste given the open opportunity. In another aspect of the embodiment, an appointment can be scheduled in the CRM application according to the context. Thereafter, in response to a determination that a location of a mobile computing device of the end user is not proximate to a location established for the appointment within a threshold time scheduled for the appointment, the prompt can include a warning that the end user is too far from the location to arrive at the appointment on time.

In another embodiment of the invention, a different method for CRM messaging integration can be provided. The different method can include receiving a transmission of a context of a message from a messaging application executing in memory of a computer in a process address space that differs from a co-executing CRM application. The different method also can include retrieving from the co-executing CRM application CRM data pertaining to the context. Finally, the different method can include transmitting the CRM data to the messaging application for display in a prompt in a user interface for the messaging application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for CRM messaging integration;

FIG. 2 is a schematic illustration of a CRM data processing system configured for CRM messaging integration; and,

FIGS. 3A and 3B, taken together, are a flow chart illustrating a process for CRM messaging integration.

### DETAILED DESCRIPTION OF THE INVENTION

Embodiments of the invention provide for CRM messaging integration. In accordance with an embodiment of the invention, a communications application executing separately from a CRM application in memory of a computing system can receive a communication from a sender of the communication. The context of the communication can be determined by parsing the content of the communication. The context of the communication in turn can be provided to the CRM application so as to trigger one or more surfacing rules present in the CRM application. The surfacing rules can be used to selectively cause the CRM application to direct the messaging application to present additional information to the end user within the communication application, for example a prompt to respond to the message sooner rather than later, or a prompt providing CRM data associated with the context of the communication.

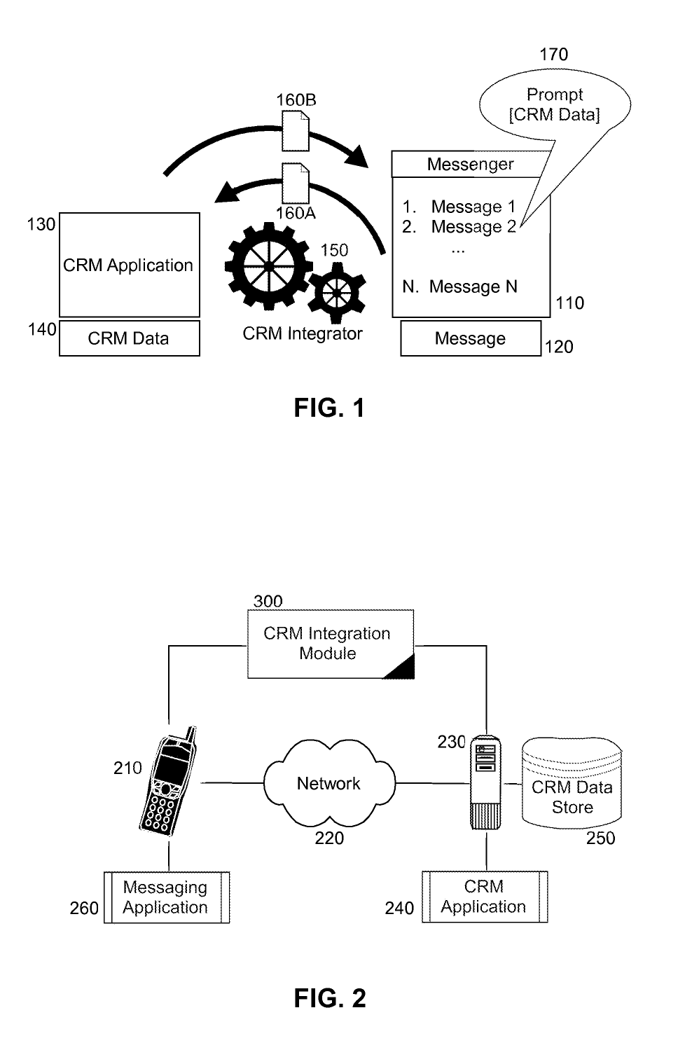

In further illustration, FIG. 1 is a pictorial illustration of a process for CRM messaging integration. As shown in FIG. 1, a CRM integrator 150 can process a message 120 in a messaging application 110 to identify a context 160A of the message 120, for instance a sender of the message 120, one or more recipients of the message 120, a subject of the message 120, or the text of the body of the message 120. The CRM integrator 150 can transmit the context 160A to a CRM application 130 in order to identify correlated information 160B for the context 160A amongst the CRM Data 140 of the CRM application 130. For instance, the context 160A of the message 120 can correlate to a business opportunity record amongst the CRM data 140, a pending appointment record amongst the CRM data 140, or a customer record amongst the CRM data 140.

Thereafter, the correlated information 160B can be provided to the messaging application 110 for inclusion in a prompt 170 displayed in a user interface of the messaging application 110. For example, the prompt 170 can indicate that an end user should send a reply to the message 120 due to a correlated business opportunity that is “open” within the CRM application 130. As another example, the prompt 170 can specify customer data in the CRM application 130 associated with a sender of the message 120. As yet another example, the prompt 170 can specify whether or not the end user is likely to attend an appointment associated with a sender of the message based upon a contemporaneously determined location of a device hosting the messaging application 110.

Optionally, the CRM application 130 can act upon the message 120 by creating an event in the CRM application 130 based upon the message 120. Further, the CRM application 130 can generate a different message to be transmitted to an end user or a third party based upon the message 120. As an additional option, the message 120 can be semantically matched to one or more objects of the CRM application 130 and logically associated therewith within the CRM application 130. As yet a further option, the determined location of the device hosting the messaging application 110 can be acted upon by the CRM application 130 by incorporating the determined location into a new message, by recording the location into a record of the CRM application 120, or by using the determined location to trigger an action or event within the CRM application 120.

The process described in connection with FIG. 1 can be implemented in a CRM data processing system. In further illustration, FIG. 2 schematically shows a CRM data processing system configured for CRM messaging integration. The system can include a host computing system 230 that includes one or more computers, each with memory and at least one processor. The host computing system 230 can support the operation of a CRM application 240 providing CRM data processing services based upon CRM data in a CRM data store 250. The host computing system 230 can be configured for communicative coupling over computer communications network 220 to a computing device 210, for example a smart phone, tablet computer, laptop computer or personal computer. The computing device 210 also can include memory and at least one processor and support the operation of a messaging application 260.

Notably, a CRM integration module 300 can be coupled to each of the computing device 210 and the host computing system 230 and execute in the memory of either or both of the computing device 210 and the host computing system 230. The CRM integration module 300 can include program code enabled upon execution in memory to can process a message in the messaging application 260 to identify a context of the message. The program code of the CRM integration module 300 subsequently can transmit the context to the CRM application in order to identify correlated information for the context amongst the CRM data of the CRM data store 250. Thereafter, the program code of the CRM integration module 300 can provide the correlated information to the messaging application 260 for inclusion in a prompt displayed in a user interface of the messaging application 260.

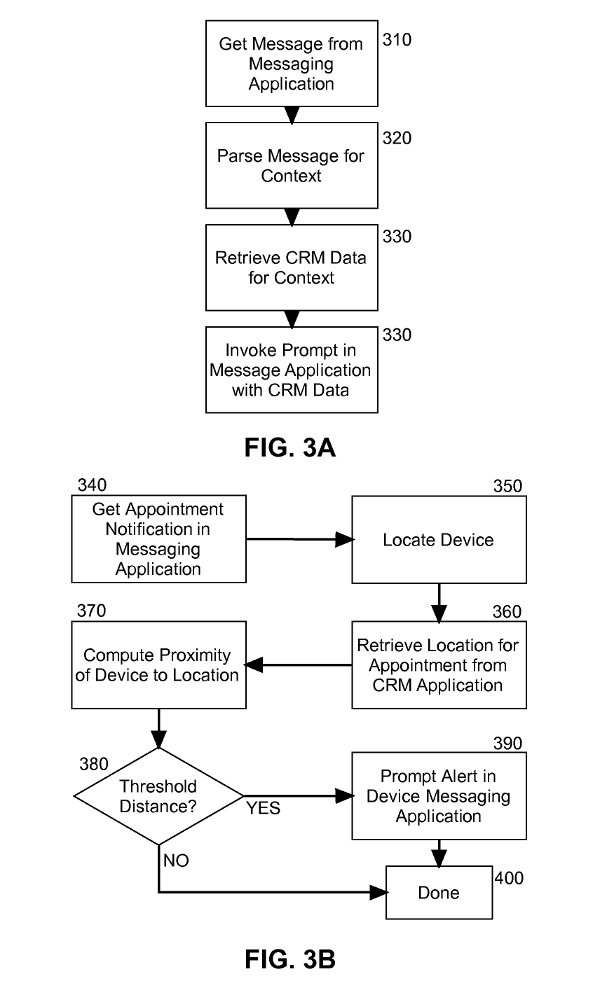

In even yet further illustration of the operation of the CRM integration module 300, FIGS. 3A and 3B, taken together, are a flow chart illustrating a process for CRM messaging integration. Beginning in block 310 of FIG. 3A, a message can be received from a messaging application. In block 320, a context for the message can be determined, for instance by parsing the message into its constituent parts in order to identify one or more of the sender of the message, one or more recipients of the message, a subject of the message, or text in a body of the message. Subsequently, in block 330, CRM information amongst CRM data of the CRM application can be correlated to the context of the message—for example, a customer record, an open business opportunity or a scheduled appointment. Finally, in block 330, a prompt can be invoked in the messaging application based upon the CRM information, such as a reminder to reply to the message with haste based upon a correlated open business opportunity, or contact information or sales information for a correlated customer record in the CRM application.

FIG. 3B provides particular illustration of an embodiment in which a pending appointment managed in the messaging application is correlated to location data in a CRM application in order to determine whether or not a device hosting the messaging application is in reasonable proximity to a location for the appointment so as to assure attendance at the appointment. In this regard, in block 340 an appointment notification message can be received in the messaging application. In block 350 a location of the device hosting the messaging application can be determined. In block 360, a location of the appointment can be retrieved and in block 370 a proximity of the device to the location of the appointment can be computed. In decision block 380, if the computed distance exceeds a threshold value so as to indicate a likelihood that the device will not be positioned at the location of the appointment by the scheduled time of the appointment, a prompt can be issued in the messaging application at block 390 alerting the end user of the appointment. Finally, the process can end in block 400.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for customer relationship management (CRM) messaging integration, the method comprising:
receiving a message in a messaging application executing in memory of a computer in a process address space that differs from a co-executing CRM application;
parsing at least a part of the message to determine a context for the message;
transmitting the context for the message to the co-executing CRM application;
receiving from the CRM application CRM data pertaining to the context; and,
displaying a prompt in a user interface for the messaging application with the CRM data.

2. The method of claim 1, wherein the context is a sender of the message.

3. The method of claim 1, wherein the context is a recipient of the message.

4. The method of claim 1, wherein the context is text in a body of the message.

5. The method of claim 1, wherein the CRM data includes an identity of a customer referenced in the CRM application an open business opportunity record associated in the CRM application with the customer and a CRM end user responsible for the open business opportunity.

6. The method of claim 1, further comprising:
scheduling in the CRM application an appointment according to the context; and,
responsive to a determination that a location of a mobile computing device of the end user is not proximate to a location established for the appointment within a threshold time scheduled for the appointment, displaying in the prompt a warning that the end user is too far from the location to arrive at the appointment on time.

7. A method for customer relationship management (CRM) messaging integration, the method comprising:
receiving a transmission of a context of a message from a messaging application executing in memory of a computer in a process address space that differs from a co-executing CRM application;
retrieving from the co-executing CRM application CRM data pertaining to the context; and,
transmitting the CRM data to the messaging application for display in a prompt in a user interface for the messaging application.

8. The method of claim 7, wherein the context is a sender of the message.

9. The method of claim 7, wherein the context is a recipient of the message.

10. The method of claim 7, wherein the context is text in a body of the message.

11. The method of claim 7, wherein the CRM data includes an identity of a customer referenced in the CRM application, an open business opportunity record associated in the CRM application with the customer and a CRM end user responsible for the open business opportunity.

12. A computer program product for customer relationship management (CRM) messaging integration, the computer program product comprising a computer readable storage medium having program instructions embodied therewith, the program instructions executable by a device to cause the device to perform a method comprising:
receiving by a device, a transmission of a context of a message from a messaging application executing in memory of a computer in a process address space that differs from a co-executing CRM application;
retrieving by the device, from the co-executing CRM application CRM data pertaining to the context; and,
transmitting by the device, the CRM data to the messaging application for display in a prompt in a user interface for the messaging application.

13. The computer program product of claim 12, wherein the context is a sender of the message.

14. The computer program product of claim 12, wherein the context is text in a body of the message.

15. The computer program product of claim 12, wherein the context is a recipient of the message.

16. The computer program product of claim 12, wherein the CRM data both an identity of a customer referenced in the CRM application and also an open business opportunity record associated in the CRM application with the customer.
